(19) United States
(12) Patent Application Publication
(10) Pub. No.: US 2026/0217740 A1
(43) Pub. Date: Jul. 30, 2026

(54) METHOD FOR PREPARING SILANOL-FUNCTIONAL ORGANOSILICON COMPOUNDS

(71) Applicants: Dow Silicones Corporation, Midland, MI (US); Dow Global Technologies LLC, Midland, MI (US)

(72) Inventors: Zachary Kean, Midland, MI (US); Marc-Andre Courtemanche, Midland, MI (US); Mike Ferritto, Midland, MI (US); John Roberts, Midland, MI (US); Ryan Maar, Midland, MI (US)

(21) Appl. No.: 19/143,409

(22) PCT Filed: Mar. 11, 2024
(86) PCT No.: PCT/US2024/019332

§ 371 Date: Jun. 26, 2025

Related U.S. Application Data
(60) Provisional application No. 63/461,105, filed on Apr. 21, 2023.

(51) Int. Cl. C07F 7/18

(52) U.S. Cl. CPC C07F 7/188

(57) ABSTRACT

A method for preparing a silanol-functional organosilicon compound from a silyl hydride and an oxidant is provided. The oxidant includes peroxyacetic acid.

### CROSS REFERENCE TO RELATED APPLICATIONS

This application claims the benefit of U.S. Provisional Patent Application Ser. No. 63/461,105 filed on 21 Apr. 2023 under 35 U.S.C. § 119 (e). U.S. Provisional Patent Application Ser. No. 63/461,105 is hereby incorporated by reference.

### FIELD

A method for preparing silanol-functional organosilicon compounds is provided.

### INTRODUCTION

Silanol-functional organosilicon compounds are useful in the production of many siloxane intermediates and formulations, such as room temperature vulcanizable (RTV) formulations. However, silanol-functional organosilicon compounds can be difficult to synthesize in a controlled manner without further condensation of the silanol (Si—OH) moieties to siloxane (Si—O—Si) moieties. Various methods for synthesizing silanol-functional organosilicon compounds have been proposed, however, use of transition metal compounds as catalysts add cost and process steps to remove the catalysts from the final reaction product. Silane hydrolysis with oxidants, i.e., dioxiranes, meta-chloroperoxybenzoic acid (mCPBA), and perbenzoic acid and potassium permanganate, have been proposed, however some of these oxidants may not be commercially available, and these oxidants can result in one or more drawbacks such as side products that are difficult to remove and/or unstable silanol-functional organosilicon products.

There is an industry need to produce silanol-functional organosilicon compounds that minimize or eliminate one or more of the drawbacks associated with these oxidants.

### SUMMARY

A method for preparing a silanol-functional organosilicon compound is provided. The method comprises: combining starting materials comprising a silyl hydride and peroxyacetic acid, under conditions to effect synthesis of an Si—OH moiety.

### DETAILED DESCRIPTION

The method introduced above may comprise:
1) combining, under conditions to effect synthesis of an Si—OH moiety, starting materials comprising
   A) the silyl hydride,
   optionally B) a solvent,
   C) the peroxyacetic acid,
   optionally D) a neutralizing agent;
      thereby forming the reaction mixture comprising the silanol-functional organosilicon compound.

### A) Silyl Hydride

Starting material A) in the method described herein is a silyl hydride. The silyl hydride may be A-1) a hydridosilane or A-2) an organohydrogensiloxane. Starting material A-1), the hydridosilane, has formula HSiR¹₃, where each R¹ is an independently selected monovalent organic group.

In the formula above, each R¹ is an independently selected monovalent organic group. Alternatively, each R¹ may be independently selected from the group consisting of alkyl groups of 1 to 18 carbon atoms, alkenyl groups of 2 to 18 carbon atoms, and aryl groups of 6 to 18 carbon atoms. Suitable alkyl groups include, but are not limited to, linear and branched alkyl groups such as methyl, ethyl, propyl (including n-propyl and isopropyl), butyl (including n-butyl, iso-butyl, sec-butyl, and t-butyl), pentyl, hexyl, heptyl, octyl, decyl, dodecyl, undecyl, octadecyl (including linear and branched alkyl groups of 5 to 18 carbon atoms) and cyclic alkyl groups such as cyclopentyl and cyclohexyl. Suitable alkenyl groups include vinyl, allyl, and hexenyl. Suitable aryl groups include, but are not limited to phenyl, tolyl, xylyl, naphthyl, benzyl, 1-phenylethyl, and 2-phenylethyl.

Alternatively, R¹ may comprise a halogenated hydrocarbon group or a hydrocarbon substituted with an oxygen atom. Suitable halogenated hydrocarbon groups for R¹ may be any of the monovalent hydrocarbon groups described an exemplified above, wherein at least one hydrogen atom bonded to a carbon atom has been formally replaced with a halogen atom, such as bromo, chloro, or fluoro; alternatively chloro or fluoro, and alternatively chloro. For example, the halogenated hydrocarbon group may be a fluoroalkyl group such as trifluoromethyl (CF₃), fluoromethyl, trifluoroethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl; or a chloroalkyl group such as chloromethyl, 3-chloropropyl 2,2-dichlorocyclopropyl, 2,3-dichlorocyclopentyl. Haloalkenyl groups include chloroallyl.

Alternatively, the hydrocarbon group substituted with an oxygen atom for R¹ may be a (meth) acrylate-functional group, such as an alkyl (meth)acrylate group, e.g., propyl methacrylate, propyl acrylate, butyl methacrylate, or butyl acrylate or an alkoxy group of formula-OR, where R is an alkyl group or an aryl group, which may be an alkyl group or aryl group as described and exemplified above for R¹. Alternatively, the alkoxy group may be, for example, methoxy, ethoxy, propoxy, or butoxy.

Examples of suitable hydridosilanes for starting material A) are exemplified by trimethylsilane of formula HSiMe₃, triethylsilane of formula HSiEt₃, dimethylphenylsilane, diphenylmethylsilane, tert-butyl(dimethyl) silane, tri (isopropyl) silane, triethoxysilane, diethylsilane, vinyldimethylsilane, chloropropyldimethylsilane and triphenylsilane. Alternatively, the silyl hydride may be selected from the group consisting of triethylsilane, dimethylphenylsilane, and triphenylsilane.

Alternatively, the silyl hydride compound may comprise A-2) an organohydrogensiloxane comprising two or more siloxane units selected from, HR¹₂SiO_{1/2}, R¹₃SiO_{1/2}, HR¹SiO_{2/2}, R¹₂SiO_{2/2}, R¹SiO_{3/2}, HSiO_{3/2} and SiO_{4/2} units, with the proviso that at least one unit per molecule contains a silicon bonded hydrogen atom. In the preceding formulae, each R¹ is a monovalent organic group, as described and exemplified above. The organohydrogensiloxane may be linear, branched, cyclic, resinous, or a combination thereof. Alternatively, the organohydrogensiloxane may be linear or branched. Alternatively, the organohydrogensiloxane may be linear.

Starting material A-2), the organohydrogensiloxane, may have unit formula (I): (R¹₃SiO_{1/2})ₐ(HR¹₂SiO_{1/2})_{b}(R¹₂SiO_{2/2})_{c}(HR¹SiO_{2/2})_{d}(R¹SiO_{3/2})ₑ(HSiO_{3/2})_{f}(SiO_{4/2})_{g}(ZO_{1/2})ₕ, where each R¹ is the monovalent organic group; each Z independently represents H or an alkyl group of 1 to 6 carbon atoms; subscripts a to g represent average numbers of each siloxane unit per molecule, subscript h represents number of hydrolyzable groups per molecule, and subscripts a to h have values such that: a≥0, b≥0, c≥0, d≥0, e≥0, f≥0, g≥0, h≥0, a quantity (b+d+f)≥1, and 2≤(a+b+c+d+e+f+g)≤10,000. In unit formula (I), R¹ is a monovalent organic group as described above for the silane. Alternatively, in unit formula (I), each R¹ may be an independently selected alkyl group or aryl group as described above.

Alternatively, A-2) the organohydrogensiloxane may be substantially linear or linear, e.g., when subscripts e, f, g, and h are each 0. Alternatively, starting material A-2) may comprise unit formula (II): (R¹₃SiO_{1/2})ₐ(HR¹₂SiO_{1/2})_{b}(R¹₂SiO_{2/2})_{c}(HR¹SiO_{2/2})_{d}, where R¹, a, b, c, and d are as described above, a quantity (a+b)=2, and a quantity (b+d)≥1. In formula (II), a quantity (c+d) may have a value of 0 to 200, alternatively 0 to 150, alternatively 0 to 100, alternatively 0 to 99, and alternatively 1 to 99. Alternatively, in formula (II), when d=0, then b is 1 or 2. Alternatively, the quantity (b+d) may be 1 to 10, alternatively 1 to 9, alternatively 1 to 8, and alternatively 1 to 7.

Alternatively, A-2) the linear organohydrogensiloxane may be a (meth)acrylate functional organohydrogensiloxane and may comprise formula (III):

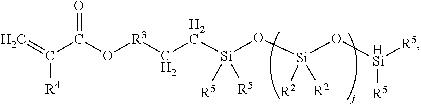

where each R⁵ is independently selected from the group consisting of an alkyl group of 1 to 6 carbon atoms and an aryl group of 6 to 10 carbon atoms; each R² is independently selected from the group consisting of an alkyl group of 1 to 6 carbon atoms and an aryl group of 6 to 10 carbon atoms; R³ is an alkane-diyl group of 1 to 10 carbon atoms, R⁴ is hydrogen or an alkyl group of 1 to 6 carbon atoms, and subscript j is 0 to 20, alternatively 0 or 1. Alternatively, the (meth)acrylate functional organohydrogensiloxane may have each R⁵ is a methyl group, each R² is a methyl group, R³ is methane-diyl, R⁴ is a methyl group, and subscript j=0. Examples include 3-(1,1,3,3-tetramethyldisiloxaneyl)propyl methacrylate of formula

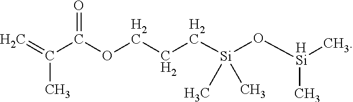

(Meth)acrylate-functional organohydrogensiloxanes and methods for their preparation are disclosed, for example, in EP3387045A to Eldred, et al.

Alternatively, A-2) may be branched. For example, starting material A-2) may comprise unit formula (IV) or (V), where
unit formula (IV) is: (R¹₃SiO_{1/2})ₐ(HR¹₂SiO_{1/2})_{b}(R¹²SiO_{2/2})_{c}(HR—SiO_{2/2})_{d}(R¹SiO_{3/2})ₑ(HSiO_{3/2})_{f}, and
unit formula (V) is: (R¹₃SiO_{1/2})ₐ(HR¹₂SiO_{1/2})_{b}(R¹₂SiO_{2/2})_{c}(HR¹SiO_{2/2})_{d}(SiO_{4/2})_{g},
   where R¹, a, b, c, d, e, f, and g are as described above.
      Alternatively, in formulae (IV) and (V) above, each R¹ may be an alkyl group or an aryl group as described above for R. Alternatively, each R¹ may be an alkyl group, as described above for R. Examples of branched organohydrogensiloxanes are known in the art. For example, tris(trimethylsiloxy)silane (Me₃SiO_{1/2})₃SiH is commercially available from Sigma-Aldrich of St. Louis, Missouri, USA.

Alternatively, A-2) may be an alkoxy-functional organohydrogensiloxane, which may be linear or branched. For example, the alkoxy-functional organohydrogensiloxane may have formula

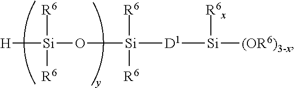

where each D¹ is an independently selected alkane-diyl group, each R⁶ is an independently selected alkyl group, which may be as described above for the alkyl group for R, subscript y is 1 or 2, and subscript x is 1, 2, or 3. Alternatively, x may be 2 or 3. Alternatively, x may be 3. Alternatively, subscript y may be 1. Alternatively, each R⁶ may be methyl. The alkane-diyl group D¹ may have empirical formula —C_{z}H_{2z}—, where subscript z is 2 to 6. Alternatively, z may be 2 to 4, alternatively 2 to 3. Alternatively, at least 90% of all instances of D¹ may be linear. For example, at least 90% of all instances of D¹ may be —CH₂—CH₂—. Alternatively, in formula (VI) each R⁶ may be methyl, and each D¹ may have empirical formula-C₂H₄—. Alternatively, formula (VI) may comprise 1,1,3,3,5,5-hexamethyl-1-(2-(trimethoxysilyl)ethyl) trisiloxane of formula

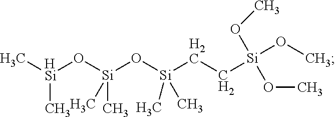

1,1,3,3-tetramethyl-1-(2-(trimethoxysilyl)ethyl)disiloxane of formula

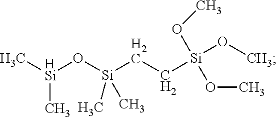

or a combination thereof. Alternatively, formula (VI) may comprise 1,1,3,3-tetramethyl-1-(1-(trimethoxysilyl)ethyl)disiloxane and 1,1,3,3-tetramethyl-1-(2-(trimethoxysilyl)ethyl)disiloxane.

Alternatively, the alkoxy-functional organohydrogensiloxane may have formula (VII):

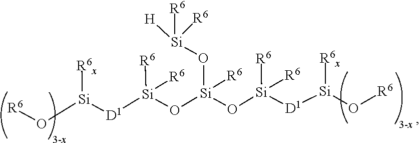

where R⁶, D¹, and subscript x are as described above. Alternatively, formula (VII) may comprise 7-(dimethylsilyl)oxy)-3,3,11,11-tetramethoxy-4,5,5,7,9,9,10-heptamethyl-2,6,8,12-tetraoxa-3,5,7,9,11-pentasilatridecane of formula

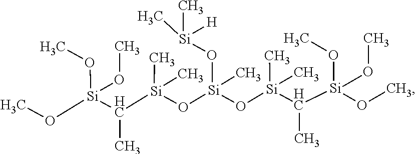 [SMILES: COC[Si](OC)(OC)C(C)[Si](C)(C)O[Si](C)(O[SiH](C)C)O[Si](C)(C)C(C)[Si](OC)(OC)OC]

8-((dimethylsilyl)oxy)-3,3,13,13-tetramethoxy-6,6,8,10,10-pentamethyl-2,7,9,14-tetraoxa-3,6,8,10,13-pentasilapentadecane of formula

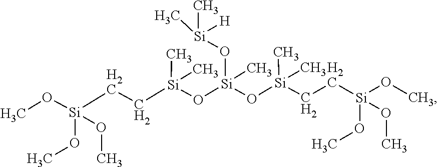 [SMILES: CO[Si](CCC[Si](C)(C)O[Si](C)(O[SiH](C)C)O[Si](C)(C)CC[Si](OC)(OC)OC)(OC)OC]

or a mixture thereof. Alternatively, formula (VII) may comprise 8-((dimethylsilyl)oxy)-3,3,13,13-tetramethoxy-6,6,8,10,10-pentamethyl-2,7,9,14-tetraoxa-3,6,8,10,13-pentasilapentadecane. Alkoxy-functional organohydrogensiloxanes are known in the art and may be made by known methods, such as those described in U.S. Pat. No. 10,968,317 to Gohndrone, et al; U.S. Pat. No. 11,098,163 to Gohndrone, et al; U.S. Pat. No. 11,161,939 to Zhou, et al.; U.S. Pat. No. 11,168,181 to Zhou, et al.; and 11,492,448 to Gohndrone, et al; and JP2007077136 to Uehara, et al.

Alternatively, polyorganohydrogensiloxanes for starting material A-2) are exemplified by:
a) dimethylhydrogensiloxy-terminated polydimethylsiloxane;
b) dimethylhydrogensiloxy-terminated poly(dimethyl/methylhydrogen) siloxane;
c) dimethylhydrogensiloxy-terminated polymethylhydrogensiloxane;
d) trimethylsiloxy-terminated poly(dimethylsiloxane/methylhydrogensiloxane);
e) trimethylsiloxy-terminated polymethylhydrogensiloxane;
f) 1,1,3,3,3-pentamethyldisiloxane;
g) 1,1,3,3-tetramethyldisiloxane;
h) 1,1,1,3,5,5,5-heptamethyltrisiloxane;
i) 3-(1,1,3,3-tetramethyldisiloxaneyl)propyl methacrylate;
j) 1,1,3,3-tetramethyl-1-(2-(trimethoxysilyl)ethyl)disiloxane;
k) tris(trimethylsiloxy)silane;
l) 8-((dimethylsilyl)oxy)-3,3,13,13-tetramethoxy-6,6,10,10-tetramethyl-8-propyl-2,7,9,14-tetraoxa-3,6,8,10,13-pentasilapentadecane;
m) a resin consisting essentially of H(CH₃)₂SiO_{1/2} units and SiO_{4/2} units; and
n) a combination of two or more thereof.

Polyorganohydrogensiloxanes are also commercially available, such as those available from Gelest, Inc. of Morrisville, Pennsylvania, USA, for example, HMS-H271, HMS-071, HMS-993; HMS-301 and HMS-301 R, HMS-031, HMS-991, HMS-992, HMS-993, HMS-082, HMS-151, HMS-013, HMS-053, HAM-301 (octyl functional), HPM-502 (phenyl functional) and HMS-HM271. Other polyorganohydrogensiloxanes include DOWSIL™ 6-3570 Polymer, DOWSIL™ SH1107 Fluid, XIAMETER™ MHX-11007 Fluid, and XIAMETER™ OFS-5057 Fluid, all of which are commercially available from Dow. Methods of preparing linear, branched, and cyclic organohydrogenpolysiloxanes suitable for use herein, such as hydrolysis and condensation of organohalosilanes, are well known in the art, see for example U.S. Pat. No. 3,957,713 to Jeram et al. and U.S. Pat. No. 4,329,273 to Hardman, et al. Methods of preparing organohydrogenpolysiloxane resins suitable for use herein are exemplified, e.g., in U.S. Pat. Nos. 5,310,843; 4,370,358; and 4,707,531. And, U.S. Pat. No. 2,823,218 to Speier, et al., discloses organohydrogensiloxane oligomers and linear polymers, e.g., 1,1,3,3-tetramethyldisiloxane; 1,1,1,3,3-pentamethyldisiloxane; 1,1,1,3,5,5,5-heptamethyltrisiloxane; bis-trimethylsiloxy-terminated polymethylhydrogensiloxane homopolymer; bis-trimethylsiloxy-terminated poly(dimethyl/methylhydrogen) siloxane copolymer; and cyclic polymethylhydrogensiloxanes.

The amount of starting material A) depends on various factors including the process conditions selected and the content of silicon bonded hydrogen atoms. However, starting materials A) and C) may be used in amounts sufficient to provide an amount of C) peroxyacetic acid from 1 to 2 molar equivalents of C) peroxyacetic acid to silicon bonded hydrogen content of A).

### B) Solvent

Starting material B) is an optional solvent that may be used in the method described herein to aid mixing of starting materials A) and C). For example, A) the silyl hydride may be dissolved in B) the solvent before combining A) the silyl hydride and C) the peroxyacetic acid. Solvents that can be used herein are those that help fluidize starting materials A) and C), but essentially do not react therewith. The solvent may be selected based on solubility of starting materials A) and C) and volatility of the solvent. The solubility refers to the solvent being sufficient to dissolve and/or disperse a starting material. Volatility refers to vapor pressure of the solvent. For example, if the solvent is not volatile enough (too low vapor pressure) the solvent may be difficult to remove after step 1).

Suitable solvents include polyorganosiloxanes with suitable vapor pressures, such as hexamethyldisiloxane, octamethyltrisiloxane, hexamethylcyclotrisiloxane and other low molecular weight polyorganosiloxanes, such as 0.5 to 1.5 cSt DOWSIL™ 200 Fluids and DOWSIL™ OS FLUIDS, which are commercially available from Dow.

Alternatively, the solvent may comprise an organic solvent. The organic solvent can be an alcohol such as methanol, ethanol, isopropanol, butanol, or n-propanol; a ketone such as acetone, methylethyl ketone, or methyl isobutyl ketone; an aromatic hydrocarbon such as benzene, toluene, ethylbenzene or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, a halogenated hydrocarbon such as dichloromethane, 1,1,1-trichloroethane or methylene chloride; chloroform; dimethyl sulfoxide; dimethyl formamide, acetonitrile; tetrahydrofuran; white spirits; mineral spirits; naphtha; n-methyl pyrrolidone; or a combination thereof.

The amount of solvent will depend on various factors including the type of solvent selected and the amount and type of other starting materials selected for use in the method. However, the amount of solvent may range from 1% to 99%, alternatively 2% to 90%, based on the weight of all starting materials used in step 1) of the method described herein. Solvent can be added during preparation of the reaction mixture, for example, to aid mixing and delivery. All or a portion of the solvent may optionally be removed after step 1).

### C) Peroxyacetic Acid

Starting material C) used in the method described herein comprises peroxyacetic acid, which has formula:

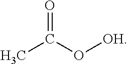

Without wishing to be bound by theory, it is thought that peroxyacetic acid acts as an oxidant, thereby forming a silanol (Si—OH) moiety from an Si—H moiety of starting material A) in step 1) of the method described herein. Peroxyacetic acid (peracetic acid) is known in the art and commercially available. For example, peracetic acid solution (32 wt % of peracetic acid in dilute acetic acid) is commercially available from Sigma-Aldrich, Inc. Without wishing to be bound by theory, it is thought that peroxyacetic acid is made by condensing hydrogen peroxide with acetic acid in aqueous solution, so the peroxyacetic acid useful herein may further comprise residual hydrogen peroxide and/or acetic acid, which has formula

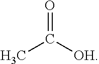

### D) Neutralizing Agent

Starting material D) is an optional neutralizing agent that may be used in the method described herein. Without wishing to be bound by theory, it is thought that peroxyacetic acid comprises residual mineral acid (e.g., in the commercially available peracetic acid, pH is <1). The neutralizing agent may be added to prevent or minimize undesired condensation. For example, a a mildly basic neutralizing agent may be added in an amount sufficient to give C) the peroxyacetic acid a pH of 3 to 4, where condensation is relatively slow. Starting material D) the neutralizing agent may be added with the other starting materials in step 1), or starting materials comprising C) the peroxyacetic acid may be combined with D) the neutralizing agent before combining with starting material A) the silyl hydride in step 1). Suitable neutralizing agents include sodium carbonate, sodium bicarbonate, calcium carbonate CaO₃, and potassium carbonate, all of which are commercially available, for example, from Sigma-Aldrich, Inc.
Step 1) of the method comprises combining the starting materials described above under conditions to effect synthesis of an Si—OH moiety. The starting materials may be combined by any convenient means, such as mixing, in any convenient equipment such as a batch reactor optionally with an agitator and heating and cooling means. Step 1) of the method may be performed at elevated temperature, such as >RT to <110° C. (the boiling point of peroxyacetic acid), alternatively 50° C. to 75° C.

The method described herein may optionally further comprise one or more additional steps. For example, the additional steps may comprise:
2) drying the reaction mixture comprising the silanol-functional organosilicon compound, and/or
3) isolating the silanol-functional organosilicon compound. Drying in step 2) may be performed by any convenient means. For example, a drying agent, such as a commercially available adsorbent may be combined with the reaction mixture. Examples of suitable adsorbents may be inorganic particulates. The adsorbent may have a particle size of 10 micrometers or less, alternatively 5 micrometers or less. The adsorbent may have average pore size sufficient to adsorb water and alcohols, for example 10 Å (Angstroms) or less, alternatively 5 Å or less, and alternatively 3 Å or less. Examples of adsorbents include zeolites such as chabasite, mordenite, and analcite; molecular sieves such as alkali metal alumino silicates, silica gel, silica-magnesia gel, activated carbon, activated alumina, calcium oxide, and combinations thereof. In step 3), the silanol-functional organosilicon compound may be isolated by any convenient means, such as filtering (e.g., to remove a drying agent from step 2), stripping and/or distillation optionally with heating and/or reduced pressure. The resulting product is a silanol functional organosilicon compound derived from starting material A) the silyl hydride, wherein at least one silicon bonded hydrogen from the silyl hydride has been converted to a silanol moiety.

### EXAMPLES

These examples are intended to illustrate the invention to one skilled in the art and are not to be construed so as to limit the invention set forth in the claims. Starting materials used herein are described in Table 1.

TABLE 1
Starting Materials

| Substance | Role | Description | Source |
|---|---|---|---|
| Polysiloxane 1 (MD_{92.3}D′_{6.2}M) | substrate | Bis-trimethylsiloxy-terminated, | Dowsil |
| | | poly(dimethyl/methylhydrogen) | IT EL |
| | | siloxane with 0.84% SiH) | 2- |
| | | | 6770S |
| | | | from |
| | | | Dow |
| Peracetic Acid (PAA) of formula | oxidant | Peracetic acid solution (32 wt. | Sigma- |
| CH₃CO₂OH | | % in dilute acetic acid) | Aldrich |
| Hydrogen Peroxide (H₂O₂) | oxidant | 30 wt % in water | Sigma- |
| | | | Aldrich |
| tert-butyl hydroperoxide (tBuOOH) | oxidant | 5.5M in decane | Sigma- |
| | | | Aldrich |
| meta-chloroperoxybenzoic acid | oxidant | ≤77% | Sigma- |
| (mCPBA) | | | Aldrich |
| Triethylsilane of formula Et₃SiH | substrate | 99% | Sigma- |
| | | | Aldrich |
| Dimethylphenyl silane (Me₂PhSiH) | substrate | >98% | Sigma- |
| | | | Aldrich |
| Triphenylsilane (Ph₃SiH) | substrate | 97% | Sigma- |
| | | | Aldrich |
| Pentamethyldisiloxane (MM′) | substrate | >95% | Gelest |
| 1,1,1,3,5,5,5- | substrate | 97% | Sigma- |
| Heptamethyltrisiloxane (MD′M) | | | Aldrich |
| Tris(trimethylsiloxy)silane (M₃T′) | substrate | >98% | Sigma- |
| | | | Aldrich |
| Tetraethylsilane (Et₄Si) (TES) | standard | 99% | Sigma- |
| | | | Aldrich |
| 3-(1,1,3,3- | substrate | | Dow |
| tetramethyldisiloxaneyl)propyl | | | |
| methacrylate (MA Siloxane) | | | |
| 1,1,3,3-tetramethyl-1-(2- | substrate | | Dow |
| (trimethoxysilyl)ethyl)disiloxane | | | |
| (Polyalkoxy-functional siloxane 1) | | | |
| 8-((dimethylsilyl)oxy)-3,3,13,13- | substrate | | Dow |
| tetramethoxy-6,6,10,10-tetramethyl- | | | |
| 8-propyl-2,7,9,14-tetraoxa- | | | |
| 3,6,8,10,13-pentasilapentadecane | | | |
| (Polyalkoxy-functional siloxane 2) | | | |

In this Reference Example 1, Peracetic acid solution (32 wt. % in dilute acetic acid) was obtained from Sigma-Aldrich and unless stated otherwise was partially neutralized immediately prior to use to pH ~3.5 with 60 mg NaHCO₃ added per mL of the Peracetic acid solution.

In this Working Example 1 (IE1): 35 g Polysiloxane 1 was dissolved in 35 mL toluene in a 3 neck 250 mL round bottom flask. Solution was heated to 50° C. under nitrogen purge. Peracetic acid solution was added and mixture stirred vigorously for 1 hour. IR was checked and conversion was nearly complete, another 1 mL Peracetic acid solution was added and stirring continued for 30 minutes. Reaction was allowed to stir for another 30 minutes. —SiH remained unchanged, so the mixture was washed twice with 100 mL water, and once with brine, then dried over sodium sulfate and filtered (all with the aid of an additional 100 mL toluene). The resulting solution was stripped in a rotary evaporator at up to 50° C. for 90 minutes then placed under high vacuum for 15 minutes prior to analysis.

In this Working Example 2 (IE2), Polymer 1 was dissolved in 35 mL toluene in a 3 neck 250 mL round bottom flask. Solution was heated to 50° C. under nitrogen purge. Peracetic acid solution was added and mixture stirred vigorously for 1 hour. IR was checked and conversion was nearly complete, another 1 mL Peracetic acid solution was added and stirring continued for 30 minutes. Reaction was allowed to stir for another 30 minutes-SiH remained unchanged so the mixture was washed twice with 100 mL water, and once with brine, then dried over sodium sulfate and filtered (all with the aid of an additional 100 mL toluene). The resulting solution was stripped in a rotary evaporator at up to 50° C. for 90 minutes then placed under high vacuum for 15 minutes prior to analysis.

In this Reference Example 2, Working Examples 3-20 (IE3-IE20) and Comparative Examples 1-2 (CE1-CE2) were prepared as follows: Hydrosilane and TES were prepared as a solution in toluene with a known mass concentration. A typical hydrosilane concentration of ~0.2 M and TES concentration of ~0.15 M were targeted unless specified otherwise, below in Table 2. A portion of this solution was analyzed by 1H and 29Si NMR as the 0 min sample for the purposes of calculating conversion by TES standard. 1 mL of this solution was transferred to a 2 dram glass vial with stirbar, then partially neutralized Peracetic acid solution prepared as described above in Reference Example 1 was added by volume. A nitrogen line was inserted through a septum cap and the solution placed in an aluminum heating block and stirred vigorously for the indicated time at the indicated temperature. The reaction was stopped by washing the organic layer with deionized water before drying over sodium sulfate to obtain the product solution for analysis.

In this Comparative Example 3 (CE3), (35 g Polysiloxane 1 was dissolved in 35 mL toluene in a 3 neck 250 mL round bottom flask. Solution was heated to 50° C. under nitrogen purge. 1.25 equiv. mCPBA was added and mixture stirred vigorously for 1.5 hours. The resulting yellow slurry was cooled. A portion of the yellow slurry was filtered through 0.45 micron PTFE, however this yielded a still-milky white suspension. The suspension was then washed twice with 100 mL water, and once with brine, then dried over sodium sulfate and filtered (all with the aid of an additional 100 mL toluene). The resulting solution was stripped with a rotary evaporator at up to 50° C. for 90 minutes then placed under high vacuum for 15 minutes before analysis. The conversion was complete (>95%), however the material recovered was a white slurry that could not be easily filtered. The siloxane oil itself had taken on a noticeable yellow color. The concentration of chlorobenzoic acid was 4% by weight according to 1H NMR.

TABLE 2
Reaction Conditions

| | | | | | | Oxidant | | |
|---|---|---|---|---|---|---|---|---|
| | | Substrate | | Solvent | | [vs. SiH] | Temper- | |
| | Substrate | Mass | Solvent | Volume | | [molar | ature | Reaction |
| Example | Name | (mg) | Name | (mL) | Oxidant | equiv] | [° C.] | Time |
| IE1 | Polysiloxane 1 | 35000 | Toluene | 35 | PAA | 1.25 | 50 | 150 |
| IE2 | Polysiloxane 1 | 35000 | Toluene | 35 | PAA | 0.6 | 50 | 120 |
| IE3 | Triethylsilane | 24.0 | Toluene | 1 | PAA | 1.2 | 50 | 15 |
| IE4 | Triethylsilane | 24.0 | Toluene | 1 | PAA | 1.2 | 50 | 30 |
| IE5 | Triethylsilane | 24.0 | Toluene | 1 | PAA | 1.2 | 50 | 30 |
| IE6 | Triphenylsilane | 57.0 | Toluene | 1 | PAA | 1.2 | 50 | 30 |
| IE7 | Triphenylsilane | 57.0 | Toluene | 1 | PAA | 2 | 50 | 30 |
| IE8 | Triphenylsilane | 57.0 | Toluene | 1 | PAA | 2 | 50 | 90 |
| IE9 | Me₂PhSiH | 29.0 | Toluene | 1 | PAA | 1.2 | 50 | 30 |
| IE10 | Me₂PhSiH | 29.0 | Toluene | 1 | PAA | 1.2 | 50 | 30 |
| IE11 | Me₂PhSiH | 29.0 | Toluene | 1 | PAA | 2 | 50 | 90 |
| IE12 | MM′ | 31.0 | Toluene | 1 | PAA | 1.2 | 50 | 30 |
| IE14 | MD′M | 47.8 | Toluene | 1 | PAA | 1.2 | 50 | 30 |
| IE15 | MD′M | 47.8 | Toluene | 1 | PAA | 1.2 | 75 | 30 |
| IE16 | MD′M | 47.8 | Toluene | 1 | PAA | 2 | 50 | 90 |
| IE17 | M3T′ | 64.7 | Toluene | 1 | PAA | 1.2 | 50 | 30 |
| IE18 | M3T′ | 64.7 | Toluene | 1 | PAA | 1.2 | 75 | 30 |
| IE19 | M3T′ | 64.7 | Toluene | 1 | PAA | 2 | 50 | 120 |
| IE20 | M3T′ | 64.7 | Toluene | 1 | PAA | 2 | 75 | 120 |
| IE21 | Polyalkoxy- | 1170 | Toluene | 10 | PAA | 1.2 | 50 | 30 |
| | functional | | | | | | | |
| | siloxane 2 | | | | | | | |
| IE22 | Polyalkoxy- | 565 | Toluene | 10 | PAA | 1.2 | 50 | 30 |
| | functional | | | | | | | |
| | siloxane 1 | | | | | | | |
| IE23 | MA Siloxane | 520 | Toluene | 10 | PAA | 1.2 | 50 | 30 |
| CE1 | Triethylsilane | 24.0 | Toluene | 1 | H₂O₂ | 1.2 | 50 | 30 |
| CE2 | Triethylsilane | 24.0 | Toluene | 1 | tBuOOH | 1.2 | 50 | 30 |
| CE3 | Polysiloxane 1 | 35000 | Toluene | 35 | mCPBA | 1.25 | 50 | 150 |

TABLE 3
Silanol-Functional Polyorganosiloxanes Formed

| | | | | SiH | | |
|---|---|---|---|---|---|---|
| | | | | Conversion | SiOH | |
| | Mn | Mw | | (1H NMR)** | Formation | Calculated Formula |
| Example | (kg/mol) | (kg/mol) | Mw/Mn | (%) | (%) | (²⁹Si NMR) |
| IE1 | 6.6 | 14.3 | 2.2 | | 92*** | MD₁₀₁D′_{0.5}D^{OH}_{5.7}M |
| | 7* | 17.5* | 2.5* | | | |
| IE2 | 6.6 | 13.5 | 2.0 | | 45*** | MD₁₀₃D′_{3.4}D^{OH}_{2.8}M |
| | 6.9* | 14.4* | 2.1* | | | |
| IE3 | — | — | — | 89 | 93 | |
| IE4 | — | — | — | 96 | 95 | |
| IE5 | — | — | — | 98 | 84 | |
| IE6 | — | — | — | 52 | 55 | |
| IE7 | — | — | — | 76 | 74 | |
| IE8 | — | — | — | 95 | 96 | |
| IE9 | — | — | — | 77 | 47 | |
| IE10 | — | — | — | 94 | 54 | |
| IE11 | — | — | — | 98 | 29 | |
| IE12 | — | — | — | 88 | 85 | |
| IE14 | — | — | — | 65 | 65 | |
| IE15 | — | — | — | 86 | 50 | |
| IE16 | — | — | — | 97 | 93 | |
| IE17 | — | — | — | 2 | 9 | |
| IE18 | — | — | — | 28 | 30 | |
| IE19 | — | — | — | 31 | 33 | |
| IE20 | — | — | — | 100 | 41 | |
| IE21 | | | | 81 | 59 | |
| IE22 | | | | 90 | 54 | |
| IE23 | | | | 91 | ND | |
| CE1 | — | — | — | 0 | 0 | |
| CE2 | — | — | — | 0 | 0 | |
| CE3 | 7455 | 15570 | 2.09 | — | >95% | MD₁₀₄D^{OH}_{6.7}M |

### INDUSTRIAL APPLICABILITY

Aqueous peroxyacetic acid has been discovered to be a stoichiometric oxidant for the synthesis of silanol (Si—OH) functional organosilicon compounds from silyl hydrides (Si—H functional) with one or more of the following features:
Gives high conversions at short reaction times
Works in non-polar solvents such as toluene
Commercially available and inexpensive
Degradable to relatively benign and volatile (can be stripped) by products-hydrogen peroxide and acetic acid
Could be considered “green”-used extensively in water treatment and sanitization.
Could be used as a “finishing” reagent to remove residual/reactive SiH from materials.

Without wishing to be bound by theory, it is thought that because peracetic acid is typically considered a more mild oxidant than others (such as tBuOOH and H₂O₂ described above in Comparative Examples CE1 and CE2) that give worse reaction efficiencies, the inventors surprisingly found that peroxyacetic acid is effective for the reaction to form Si—OH moieties from Si—H moieties, and that peroxyacetic acid is effective to produce a wide variety of silanol-functional organosilicon compounds (e.g., silanes and polyorganosiloxanes with different silicon bonded organic groups, numbers of siloxane units per molecule, and structures). Furthermore, peroxyacetic acid provided the additional benefit of avoiding yellowing of the silanol-functional organosilicon compound produced (as compared to mCPBA used in Comparative Example CE3).

### Test Methods

In this application, NMR was performed as follows:

The crude solution was mixed in a 60:40 v/v ratio (solvent to sample) with a 40 mM solution of Cr (acac) 3 in CDCl₃. Both ¹H and ²⁹Si were acquired on a Bruker 500 MHz NMR. ²⁹Si NMR was acquired using a standard with D1=13 s. Conversions and yields were determined by ²⁹Si NMR by peak integration normalized versus tetraethylsilane (TES) internal standard. Conversion (%) is defined by the percent disappearance of the hydrosilane and yield (%) is defined by the percent formation of the silanol versus the theoretical yield. All peaks are referenced versus TES peak (δ=7.10 ppm).

In this application, GPC was performed as follows:

GPC samples were prepared as 2 mg/mL samples in toluene and were run on an Agilent 1260 GPC with Mixed D columns and a refractive index detector. Samples were run with a toluene eluent at a flow rate of 1.00 mL/min at a temperature of 35° C. MW and MWD was determined by standard calibration versus polystyrene standards.

### Definitions and Usage of Terms

The amounts of all starting materials in a composition total 100% by weight. The Summary and the Abstract are hereby incorporated by reference. The articles ‘a’, ‘an’, and ‘the’ each refer to one or more, unless otherwise indicated by the context of specification. The singular includes the plural unless otherwise indicated. Each embodiment or alternative presented herein may be combined with any other embodiment or alternative. The term “comprising” and derivatives thereof, such as “comprise” and “comprises” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Abbreviations used in this application are defined below in Table 4.

TABLE 4
Abbreviations

| Abbreviation | Definition |
|---|---|
| acac | acetylacetonate |
| ° C. | Degree Celsius |
| D | Difunctional dimethylsiloxy unit of formula (Me₂SiO_{2/2}) |
| D′ | Difunctional methylhydrogensiloxy unit of formula |
| | (HMeSiO_{2/2}) |
| D^{OH} | Difunctional methyl/silanol functional siloxy unit |
| | of formula [(HO)(Me)SiO_{2/2}] |
| Et | ethyl |
| GPC | Gel permeation chromatography |
| M | Monofunctional trimethylsiloxy unit of formula (Me₃SiO_{1/2}) |
| M′ | Monofunctional dimethylhydrogensiloxy unit of formula |
| | (HMe₂SiO_{1/2}) |
| M^{OH} | Monofunctional dimethyl/silanol functional siloxy |
| | unit of formula [(HO)(Me)₂SiO1_{/2}] |
| Me | methyl |
| MHz | megahertz |
| min | minute |
| mL | milliliter |
| mM | millimolar |
| Mn | Number average molecular weight |
| MW or Mw | Weight average molecular weight |
| MWD | Molecular weight distribution, defined as Mw/Mn |
| NMR | Nuclear magnetic resonance |
| s | second |
| T | Trifunctional methylsiloxy unit of formula (MeSiO_{3/2}) |
| T′ | Trifunctional hydrogensiloxy unit of formula (HSiO_{3/2}) |
| T^{OH} | Trifunctional silanol functional unit of formula HOSiO_{3/2} |
| v/v | Volume/volume |

### Embodiments of the Invention

In a first embodiment, a method for preparing a silanol-functional organosilicon compound comprises:
1) mixing and heating at a temperature up to 110° C., starting materials comprising:
   A) a silyl hydride,
   B) a solvent,
   C) peroxyacetic acid,
   optionally D) a neutralizing agent;
      thereby forming a reaction mixture comprising the silanol-functional organosilicon compound.

In a second embodiment, in the method of the first embodiment, the silyl hydride comprises a hydridosilane of formula HSiR₃, where each R is independently selected from the group consisting of alkyl groups of 1 to 18 carbon atoms and aryl groups of 6 to 18 carbon atoms.

In a third embodiment, in the method of the second embodiment, the hydridosilane is selected from the group consisting of triethylsilane, dimethylphenylsilane, and triphenylsilane.

In a fourth embodiment, in the method of the first embodiment, the silyl hydride comprises an organohydrogensiloxane.

In a fifth embodiment, in the method of the fourth embodiment, the organohydrogensiloxane is linear and comprises unit formula (R¹₃SiO_{1/2})ₐ(HR¹₂SiO_{1/2})_{b}(R¹²SiO_{2/2})_{c}(HR¹SiO_{2/2})_{d}, where each R¹ is an independently selected monovalent organic group, a≥0, b≥0, c≥0, d≥0, a quantity (a+b)=2, a quantity (b+d)≥1, and 2≤(a+b+c+d)≤10,000.

In a sixth embodiment, in the method of the fifth embodiment, the organohydrogensiloxane is selected from the group consisting of a bis-trimethylsiloxy-terminated poly (dimethyl/methylhydrogen) siloxane; 1,1,3,3,3-pentamethyldisiloxane; 1,1,3,3-tetramethyldisiloxane; 1,1,1,3,5,5,5-heptamethyltrisiloxane; 3-(1,1,3,3-tetramethyldisiloxaneyl)propyl methacrylate; and 1,1,3,3-tetramethyl-1-(2-(trimethoxysilyl)ethyl)disiloxane.

In a seventh embodiment, in the method of the fourth embodiment, the organohydrogensiloxane is branched.

In an eighth embodiment, in the method of the seventh embodiment, the branched organohydrogensiloxane is selected from the group consisting of tris(trimethylsiloxy)silane and 8-((dimethylsilyl)oxy)-3,3,13,13-tetramethoxy-6,6,10,10-tetramethyl-8-propyl-2,7,9,14-tetraoxa-3,6,8,10,13-pentasilapentadecane.

In a ninth embodiment, in the method of any one if the first to eighth embodiment, B) the solvent comprises toluene.

In a tenth embodiment, in the method of the ninth embodiment, A) the silyl hydride is dissolved in B) the solvent before mixing and heating in step 1).

In an eleventh embodiment, in the method of any one of the first to tenth embodiments, where D) the neutralizing agent is present.

In a twelfth embodiment, in the method of the eleventh embodiment, where the C) the peroxyacetic acid is combined with D) the neutralizing agent to form a solution with a pH of 3 to 4 before mixing and heating in step 1).

In a thirteenth embodiment, in the method of the twelfth embodiment, D) the neutralizing agent is selected from the group consisting of sodium carbonate, sodium bicarbonate, calcium carbonate CaO₃, and potassium carbonate.

In a fourteenth embodiment, in the method of any one of the first to thirteenth embodiments, C) the peroxyacetic acid is used in an amount of 1 to 2 molar equivalents of peroxyacetic acid based on silicon bonded hydrogen content of A) the silyl hydride.

1. A method for preparing a silanol-functional organosilicon compound, wherein the method comprises:
1. combining, under conditions to effect synthesis of an Si—OH moiety, starting materials comprising
A) a silyl hydride,
optionally B) a solvent,
C) peroxyacetic acid,
optionally D) a neutralizing agent;
thereby forming a reaction mixture comprising the silanol-functional organosilicon compound.

2. The method of claim 1, where the silyl hydride comprises a hydridosilane of formula
HSiR¹₃,
where each R¹ is an independently selected monovalent organic group.

3. The method of claim 2, where each R¹ is independently selected from the group consisting of alkyl groups of 1 to 18 carbon atoms and aryl groups of 6 to 18 carbon atoms.

4. The method of claim 3, where the hydridosilane is selected from the group consisting of triethylsilane, dimethylphenylsilane, and triphenylsilane.

5. The method of claim 1, where the silyl hydride comprises an organohydrogensiloxane of unit formula:
(R¹₃SiO_{1/2})ₐ(HR¹₂SiO_{1/2})_{b}(R¹²SiO_{2/2})_{c}(HR¹SiO_{2/2})_{d}(R¹SiO_{3/2})ₑ(HSiO_{3/2})_{f}(SiO_{4/2})_{g}(ZO_{1/2})ₕ,
where each R¹ is a monovalent organic group; each Z independently represents H or an alkyl group of 1 to 6 carbon atoms; subscripts a to g represent average numbers of each siloxane unit per molecule, subscript h represents number of hydrolyzable groups per molecule, and subscripts a to h have values such that: a≥0, b≥0, c≥0, d≥0, e≥0, f≥0, g≥0, h≥0, a quantity (b+d+f)≥1, and 2≤(a+b+c+d+e+f+g)≤10,000.

6. The method of claim 5, where the organohydrogensiloxane is linear or substantially linear and comprises unit formula
(R¹₃SiO_{1/2})ₐ(HR¹₂SiO_{1/2})_{b}(R¹²SiO_{2/2})_{c}(HR¹SiO_{2/2})_{d},
where R¹, a, b, c, and d are as described above, a quantity (a+b)=2, and a quantity (b+d)≥1.

7. The method of claim 6, where the organohydrogensiloxane is selected from the group consisting of a bis-trimethylsiloxy-terminated poly (dimethyl/methylhydrogen) siloxane; 1,1,3,3,3-pentamethyldisiloxane; 1,1,3,3-tetramethyldisiloxane; 1,1,1,3,5,5,5-heptamethyltrisiloxane; 3-(1,1,3,3-tetramethyldisiloxaneyl)propyl methacrylate; and 1,1,3,3-tetramethyl-1-(2-(trimethoxysilyl)ethyl)disiloxane.

8. The method of claim 5, where the organohydrogensiloxane is branched.

9. The method of claim 8, where the branched organohydrogensiloxane is selected from the group consisting of tris(trimethylsiloxy)silane and 8-((dimethylsilyl)oxy)-3,3,13,13-tetramethoxy-6,6,10,10-tetramethyl-8-propyl-2,7,9,14-tetraoxa-3,6,8,10,13-pentasilapentadecane.

10. The method of claim 1, where B) the solvent is present.

11. The method of claim 10, where A) the silyl hydride is dissolved in B) the solvent before C) the peroxyacetic acid is combined with A) the silyl hydride.

12. The method of claim 1, where the method further comprises heating the reaction mixture at a temperature of 50° C. to 75° C.

13. The method of claim 1, further comprising one or more additional steps, where the additional steps comprise:
2) drying the reaction mixture comprising the silanol-functional organosilicon compound, and
3. isolating the silanol-functional organosilicon compound.

14. The method of claim 1, where D) the neutralizing agent is present.

15. The method of claim 1, where C) the peroxyacetic acid is used in an amount of 1 to 2 molar equivalents of peroxyacetic acid based on silicon bonded hydrogen content of A) the silyl hydride.

16. A method for preparing a silanol-functional organosilicon compound comprises:
1) mixing and heating at a temperature up to 110° C., starting materials comprising:
A) a silyl hydride,
B) a solvent,
C) peroxyacetic acid,
optionally D) a neutralizing agent;
thereby forming a reaction mixture comprising the silanol-functional organosilicon compound.

17. The method of claim 16, where B) the solvent comprises toluene.

18. The method of claim 17, where A) the silyl hydride is dissolved in B) the solvent before mixing and heating in step 1).

19. The method of claim 16, where D) the neutralizing agent is present.

20. The method of claim 19, where C) the peroxyacetic acid is combined with D) the neutralizing agent to form a solution with a pH of 3 to 4 before mixing and heating in step 1).
